(19) United States
(12) Patent Application Publication
(10) Pub. No.: US 2010/0039815 A1
(43) Pub. Date: Feb. 18, 2010

(54) LED APPARATUS AND THE PCB THEREOF

(75) Inventor: Kun Huang JHENG, Hsinchu (TW)

Correspondence Address: WPAT, PC;INTELLECTUAL PROPERTY ATTORNEYS, 2030 MAIN STREET, SUITE 1300, IRVINE, CA, 92614, US

(73) Assignee: ADVANCED ANALOG TECHNOLOGY, INC., Hsinchu (TW)

(21) Appl. No.: 12/235,980

(22) Filed: Sep. 23, 2008

(30) Foreign Application Priority Data
Aug. 13, 2008 (TW) 097130760

(51) Int. Cl. F21V 29/00

(52) U.S. Cl. 362/249.01

(57) ABSTRACT

An LED apparatus comprises a PCB and a plurality of LEDs packaged on the PCB. The PCB materials on the area between the plurality of LEDs are partially removed to form a plurality of gaps, wherein the gaps are immediately close to the LEDs and directly dissipate heat of the LEDs.

### BACKGROUND OF THE INVENTION

1. Field of the Invention

The present invention relates to a printed circuit board (PCB), and more particularly, to a printed circuit board (PCB) for LED package.

2. Description of the Related Art

Conventional LEDs are mostly used for indicator lights on electronic devices. However, with the emergence of white LEDs, they are further applied in lighting apparatus. Since LEDs consume less power, have longer lifetime, and are more robust than conventional lighting apparatus, they are expected to be the main lighting apparatus in the future. Due to the demand for lower power consumption, for example, most backlight modules of modern mobile electronic devices, such as digital still camera, digital photo frame or GPS apparatus, are implemented by LEDs.

The performance of an LED is highly correlated with its operating temperature. If the operating temperature of an LED is too high, not only will the brightness of the LED diminish, but also the lifetime thereof will shorten. For instance, when the operating temperature of the p-n junction of an LED is 25° C., the luminous intensity of the LED is about 100 millicandela (mcd); when the operating temperature of the p-n junction of the LED is raised to 75° C., the luminous intensity of the LED diminishes to about 75 mcd; when the operating temperature of the p-n junction of the LED is raised to 125° C., the luminous intensity of the LED diminishes to about 60 mcd; when the operating temperature of the p-n junction of the LED is further raised to 175° C., the luminous intensity of the LED diminishes to about 40 mcd. It can be seen from the examples above that the impact of the rising of the operating temperature of a LED to the luminous intensity of that LED is linear.

On the other hand, the impact of the rising of the operating temperature of an LED to the lifetime of that LED is exponential. For instance, when the operating temperature of the p-n junction of an LED is 50° C., the lifetime of the LED is about 20,000 hours; when the operating temperature of the p-n junction of a LED is raised to 75° C., the lifetime of the LED reduces to about 10,000 hours; when the operating temperature of the p-n junction of an LED is raised to 100° C., the lifetime of the LED reduces to about 2,000 hours; when the operating temperature of the p-n junction of an LED is further raised to 125° C., the lifetime of the LED reduces to about only 1,000 hours. It is clear that the impact of the rising of the operating temperature of an LED on the lifetime of that LED is devastating.

In addition, the operating temperature of an LED will also affect the current flowing through the LED such that the wavelength of the emitted light is also altered. FIG. 1 shows the characteristic curve of the wavelength of the emitted light of a blue light LED versus the current flowing through the LED. As shown in FIG. 1, when the current flowing through the LED grows weaker, the wavelength of the emitted light will increase such that a color shift phenomenon will occur.

Therefore, when designing a PCB for packaging a plurality of LEDs, the heat dissipation problem is a critical issue. Accordingly, the PCB provided by the present invention efficiently solves the heat dissipation problem when packaging a plurality of LEDs.

### SUMMARY OF THE INVENTION

The LED apparatus according to one embodiment of the present invention comprises a PCB and a plurality of LEDs packaged on the PCB. The area between the plurality of LEDs on the PCB is partially removed to form a plurality of gaps.

The PCB for packaging a plurality of LEDs according to another embodiment of the present invention comprises a plurality of gaps located between the plurality of LEDs.

The heat dissipation method for a PCB according to another embodiment of the present invention, the PCB packaging a plurality of LEDs and comprising a plurality of package areas; the method comprises the steps of: removing the area on the PCB between the plurality of package areas to form a plurality of gaps; and removing the area on the PCB inside the package areas to form a plurality of holes.

### BRIEF DESCRIPTION OF THE DRAWINGS

The objectives and advantages of the present invention will become apparent upon reading the following description and upon referring to the accompanying drawings, of which:

FIG. 1 shows the characteristic curve of the wavelength of the emitted light of a blue light LED versus the current flowing through the LED;

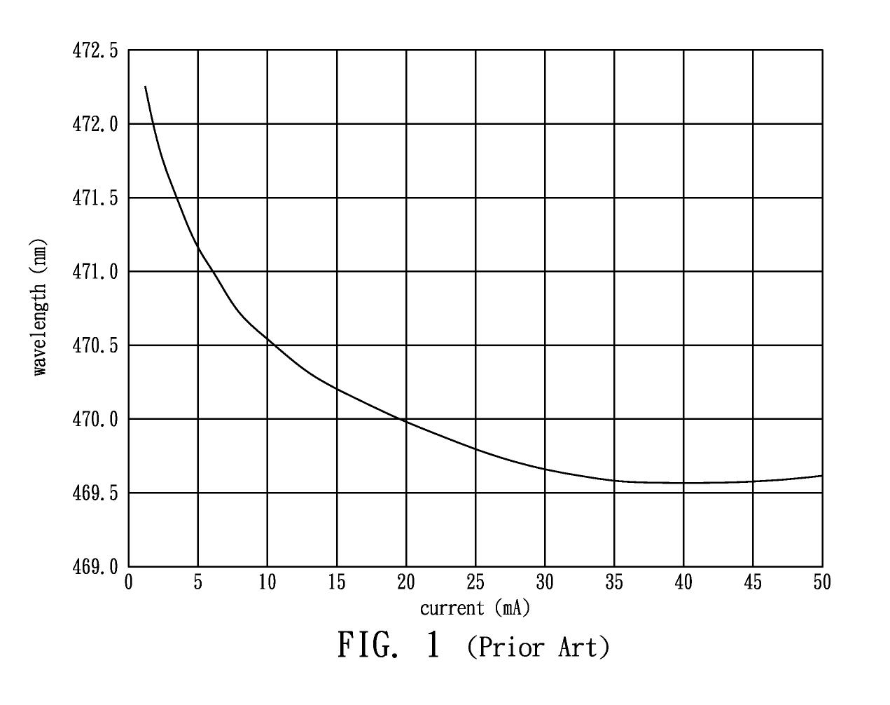

FIG. 2 shows the block diagram of a PCB according to one embodiment of the present invention;

FIG. 3 shows the block diagram of an LED apparatus according to another embodiment of the present invention; and

FIG. 4 shows the flow chart of a heat dissipation method for a PCB according to yet another embodiment of the present invention.

### DETAILED DESCRIPTION OF THE INVENTION

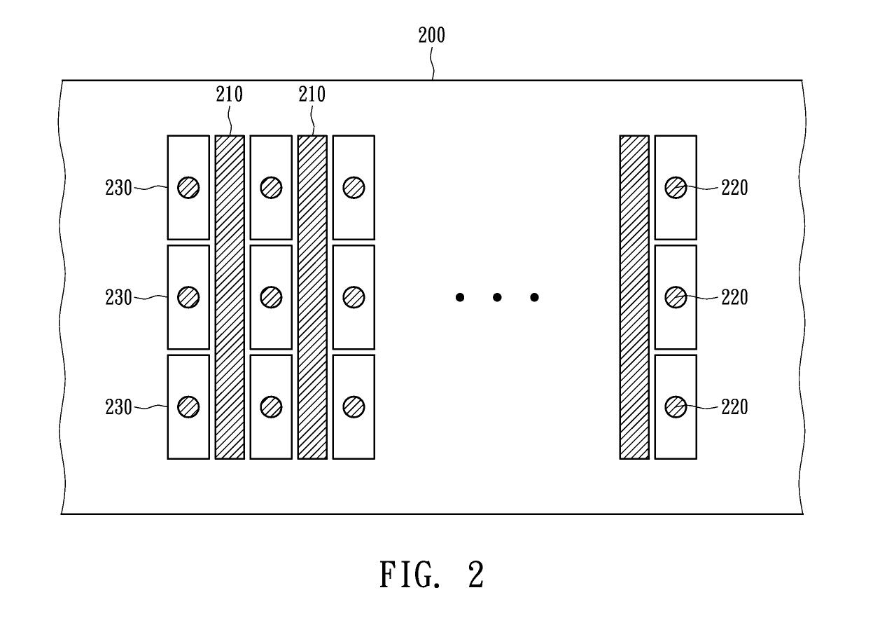

FIG. 2 shows a block diagram of a PCB according to one embodiment of the present invention. The PCB 200 packages a plurality of LEDs. The package area 230 on the PCB 200 for the plurality of LEDs to be packaged on is arranged in an array manner. The PCB 200 comprises a plurality of gaps 210 and a plurality of holes 220. As shown in FIG. 2, the area between the package areas 230 is partially removed to form the plurality of gaps 210. The area inside the package area 230 is partially removed to form the plurality of holes 220. The plurality of gaps 210 and the plurality of holes 220 help the circulation of the air near the packaged LEDs such that the ambient temperature is lowered. Preferably, the plurality of holes 220 is limited in size to protect the PCB 200 from breakage. Preferably, the shape of the plurality of gaps 210 is rectangular; wherein the length of each gap is between 7 and 13 millimeters, and the width of each gap is between 0.65 and 1.35 millimeters. More preferably, the length of each gap is 10 millimeters, and the width of each gap is 0.7 millimeter. Preferably, the shape of the plurality of holes 220 is circular or other shapes; wherein the diameter of each hole is between 0.6 and 1.2 millimeters. More preferably, the diameter of each hole is 1 millimeter.

Compared to conventional PCBs, the PCB 200 efficiently improves the heat dissipating ability. The simulation results show that for a conventional PCB, the surface temperature of the LEDs is about 50 to 51° C. For the PCB with the plurality of gaps 210, the surface temperature of the LEDs drops to about 45 to 46° C. For the PCB with both the plurality of gaps 210 and the plurality of holes 220, the surface temperature of the LEDs further drops to about 42° C. On the other hand, when operating at same duty cycle, the current flowing through the LEDs packaged on the PCB 200 is stronger and more linear than that of LEDs packaged on conventional PCBs.

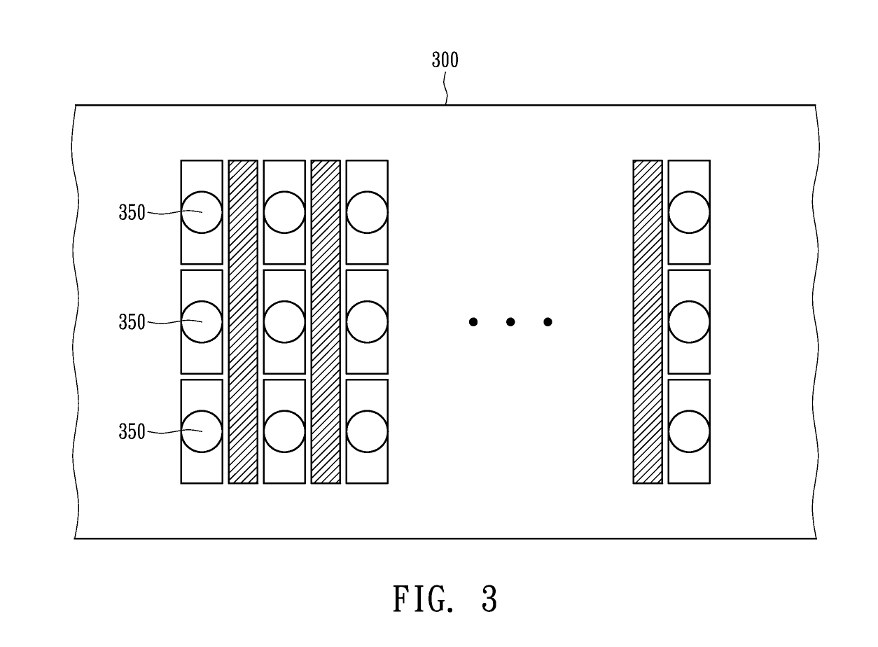

FIG. 3 shows the block diagram of an LED apparatus according to another embodiment of the present invention. The LED apparatus 300 comprises a PCB similar to the PCB 200 in FIG. 2 and plurality of LEDs 350 on the PCB. The plurality of LEDs 350 is packaged on a plurality of package areas on the PCB in FIG. 3.

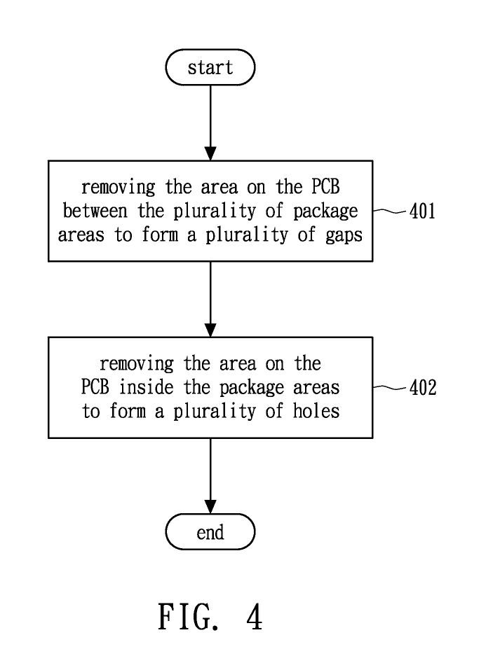

FIG. 4 shows the flow chart of a heat dissipation method for a PCB according to yet another embodiment of the present invention, wherein the PCB packages a plurality of LEDs and comprises a plurality of package areas. In step 401, the area on the PCB between the plurality of package areas is removed to form a plurality of gaps, and step 402 is executed. In step 402, the area on the PCB inside the package areas is removed to form a plurality of holes. Preferably, the shape of the plurality of gaps are rectangular, and the shape of the plurality of holes are circular.

In conclusion, the cost of the method utilized by the PCBs of the embodiments in the present invention to improve the heat dissipation abilities, i.e. removing partial areas, is relatively low. In addition, the LEDs packaged on the PCBs of the embodiments in the present invention emit lights with more efficiency, exhibit longer lifetime, and have no luminous intensity vibration or color shift problems.

The above-described embodiments of the present invention are intended to be illustrative only. Those skilled in the art may devise numerous alternative embodiments without departing from the scope of the following claims.

What is claimed is:

1. An LED apparatus, comprising:
a printed circuit board (PCB); and
a plurality of LEDs packaged on the PCB;
wherein PCB materials on the area between the plurality of LEDs are partially removed so as to form a plurality of gaps, wherein the gaps are immediately close to the LEDs and directly dissipate heat of the LEDs.

2. The LED apparatus of claim 1, wherein the plurality of LEDs are arranged in an array manner.

3. The LED apparatus of claim 2, wherein the PCB materials on the area between each column of the plurality of LEDs are partially removed to form the plurality of gaps.

4. The LED apparatus of claim 3, wherein the plurality of gaps are rectangular shaped.

5. The LED apparatus of claim 4, wherein the length of each gap is between 7 and 13 millimeters, and the width of each gap is between 0.65 and 1.35 millimeters.

6. The LED apparatus of claim 4, wherein the length of each gap is about 10 millimeters, and the width of each gap is about 0.7 millimeter.

7. The LED apparatus of claim 1, wherein the PCB materials on the area below the plurality of LEDs are partially removed to form a plurality of holes.

8. The LED apparatus of claim 7, wherein the plurality of holes are circular shaped.

9. The LED apparatus of claim 8, wherein the diameter of each hole is between 0.6 and 1.2 millimeters.

10. The LED apparatus of claim 8, wherein the diameter of each hole is about 1 millimeter.

11. A printed circuit board (PCB) for packaging a plurality of LEDs, comprising:
a plurality of gaps formed between the plurality of LEDs, wherein the gaps are immediately close to the LEDs and directly dissipate heat of the LEDs.

12. The PCB of claim 11, wherein the plurality of LEDs are arranged in an array manner.

13. The PCB of claim 12, wherein plurality of gaps are formed between the columns of the plurality of LEDs.

14. The PCB of claim 13, wherein the plurality of gaps are rectangular shaped.

15. The PCB of claim 14, wherein the length of each gap is between 7 and 13 millimeters, and the width of each gap is between 0.65 and 1.35 millimeters.

16. The PCB of claim 14, wherein the length of each gap is about 10 millimeters, and the width of each gap is about 0.7 millimeter.

17. The PCB of claim 11, wherein PCB materials on the area below the plurality of LEDs are partially removed to form a plurality of holes.

18. The PCB of claim 17, wherein the plurality of holes are circular shaped.

19. The PCB of claim 18, wherein the diameter of each hole is between 0.6 and 1.2 millimeters.

20. The PCB of claim 18, wherein the diameter of each hole is about 1 millimeter.
